(19) United States
(12) Patent Application Publication
(10) Pub. No.: US 2024/0054571 A1
(43) Pub. Date: Feb. 15, 2024

(54) MATCHING INFLUENCERS WITH CATEGORIZED ITEMS USING MULTIMODAL MACHINE LEARNING

(71) Applicant: eBay Inc., San Jose, CA (US)

(72) Inventors: Hongxu Chen, Rye (AU); Li He, Ultimo (AU); Dingxian Wang, Shanghai (CN); Xianzhi Wang, Ultimo (AU); Guangdong Xu, Oatley (AU); Haoran Yang, Mascot (AU)

(21) Appl. No.: 17/818,523

(22) Filed: Aug. 9, 2022

(51) Int. Cl. G06Q 50/00; G06N 5/02; G06N 7/00

(52) U.S. Cl. CPC G06Q 50/01; G06N 5/022; G06N 7/005

(57) ABSTRACT

Various embodiments include systems, methods, and non-transitory computer-readable media for identifying and matching influencers with categorized products using multimodal machine learning technologies. Consistent with these embodiments, a method includes identifying an influencer based on a set of criteria; determining a first attribute of the influencer based on context data associated with the influencer; identifying a second attribute of an item; generating a first vector that represents the first attribute of the influencer and a second vector that represents the second attribute of the item; generating a similarity score that represents a degree of similarity between the influencer and the item based on the first vector and the second vector; and causing display of the similarity score in a user interface of a device.

### TECHNICAL FIELD

The present disclosure generally relates to data processing using multimodal machine learning technologies. More particularly, various embodiments described herein provide for systems, methods, techniques, instruction sequences, and devices that facilitate identifying and matching influencers with categorized items.

### BACKGROUND

Existing platforms face challenges in identifying and matching influencers with items using multimodal machine learning technologies to identify potential users of the platforms. In particular, issues arise when it comes to building interest-based machine learning models to determine a degree of similarity between influencers and categorized items.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes an attribute-based matching system, according to various embodiments of the present disclosure.

FIG. 2 is a block diagram illustrating an example attribute-based matching system for influencers and categorized items, according to various embodiments of the present disclosure.

FIG. 3 is a diagram illustrating data flow within an example attribute-based matching system for influencers and categorized items during operation, according to various embodiments of the present disclosure.

FIG. 4 is flowchart illustrating an example method for identifying and matching influencers with categorized items using multimodal machine learning, according to various embodiments of the present disclosure.

FIG. 5 is flowchart illustrating an example method for identifying and matching influencers with categorized items using multimodal machine learning, according to various embodiments of the present disclosure.

FIG. 6 is a diagram illustrating an example item listing of a categorized item and the associated attributes, according to various embodiments of the present disclosure.

FIG. 7 is a diagram illustrating data flow within an example influencer interest attribute collection component during operation, according to various embodiments of the present disclosure.

FIG. 8 is a block diagram illustrating a representative software architecture, which may be used in conjunction with various hardware architectures herein described, according to various embodiments of the present disclosure.

FIG. 9 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Existing e-commerce platforms face challenges in identifying and matching influencers with items using multimodal machine learning technologies to identify potential users (e.g., customers). In particular, issues arise when identifying influencers using multimodal machine learning technologies and building interest-based machine learning models to determine a degree of similarity between identified influencers and categorized items (e.g., products).

Various examples include systems, methods, and non-transitory computer-readable media for identifying and matching influencers with categorized products using multimodal machine learning (“ML”) technologies. Multimodal ML technologies provide data analytics capabilities to process and analyze data in multiple modes including textual, visual, and acoustic information (e.g., text, image, video, and audio), thereby providing the system with a deeper and more comprehensive understanding of data content. Specifically, a multimodal ML architecture using machine learning frameworks, including an attribute-based matching system, as described in various embodiments of the present disclosure, provides for identifying influencers, particularly nano-influencers, based on context data extracted from social media platforms. The multimodal ML architecture uses various machine learning frameworks to generate vectors based on attributes of influencers and items, respectively, and determine degrees of similarity between the nano-influencers and the items. The multimodal architecture generates a sorted list of nano-influencers corresponding to one or more categorized products based on the determined degrees of similarity. Under this approach, the multimodal ML architecture is able to determine followers of the identified influencers as potential customers who may be interested in purchasing a corresponding category of products or services.

In various embodiments, the attribute-based matching system, included in the multimodal ML architecture, identifies influencer(s) based on one or more criteria. The one or more criteria may include one or more of a predetermined range of a number of followers that is associated with an upper threshold number (e.g., 10,000) and a lower threshold number (e.g., 1,000), a login frequency (e.g., a fixed number per day), a category identification (e.g., electronics), one or more hashtags (e.g., #CMOS sensor), a frequency of interaction with followers, completeness of user profile, or available contact information.

In various embodiments, the attribute-based matching system may assign one or more weight values to the one or more criteria based on a plurality of priority rules, which may be defined by the attribute-based matching system or a system administrator. The attribute-based matching system may determine a plurality of influencers based on the one or more assigned weight values and rank the determined influencers in certain orders, such as descending order. This way, the attribute-based matching system may generate a list of influencers that best satisfies the plurality of priority rules. The list of influencers includes a first listed influencer as an influencer associated with the highest weight value. For example, an influencer with a high weight value may have a number of followers within the predetermined range (e.g., 1 k-10 k), log in and interact with followers frequently (representing a high engagement rate), have a defined category (e.g., electronics) of interest, have hashtags and/or labels that further specifies the interest of the influencer and the associated followers, and have a complete user profile that includes contact information (e.g., phone number and/email address). Once matched with one or more items available for sale on the e-commerce platform, the followers of the influencer are more likely to be interested in purchasing the one or more matched items.

In various embodiments, the attribute-based matching system uses a machine learning model, such as a supervised ML learning model, to identify the one or more influencers based on one or more criteria. In various embodiments, the supervised learning model utilizes Naive Bayes classification algorithm or framework. A person of ordinary skill in the art should appreciate that Naive Bayes classification algorithm is a supervised learning algorithm or framework that applies Bayes' theorem with the “naive” assumption of conditional independence between each pair of features given the value of the class variable.

In various embodiments, the attribute-based matching system determines one or more attributes of the influencer based on context data associated with the influencer. The context data may be open-source poster data collected (or extracted) from various third-party social media platforms. The context data may include user data and media including text, image, video, audio, and metadata. Example metadata may include hashtags and labels. In various embodiments, the attribute-based matching system uses an influencer attribute collection module (also referred to as influencer interest attribute collection component, as described herein) to determine one or more attributes of the influencer based on context data associated with the influencer. In various embodiments, the attribute-based matching system uses a Graph Convolutional Networks (GCN) ML model (e.g., a first machine learning model) to determine one or more attributes of the influencer based on context data associated with the influencer.

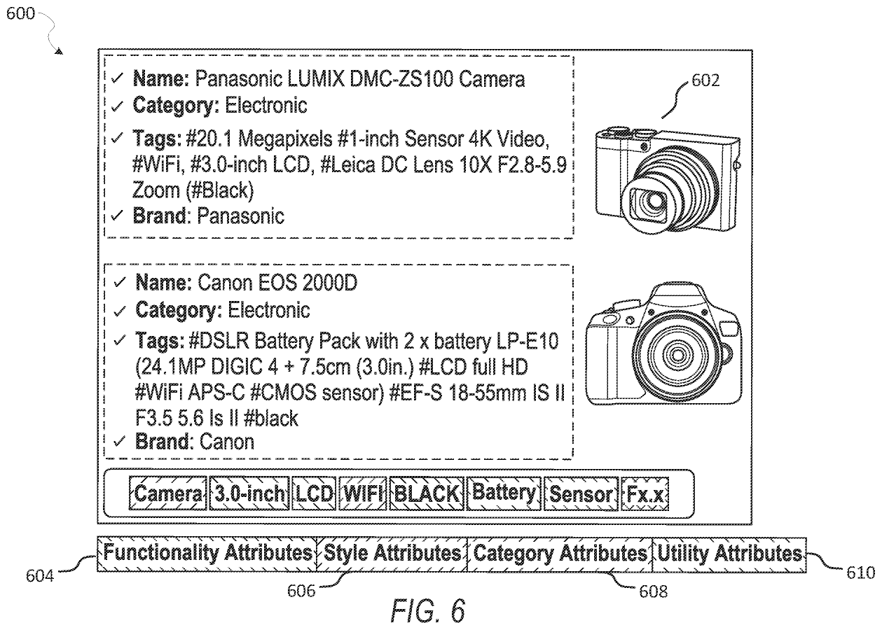

In various embodiments, the attribute-based matching system identifies one or more attributes of one or more items, such as products. In various embodiments, a product or a class of products may contain various types of attributes, including functionality attributes, style attributes, category attributes, and utility attributes, as illustrated in FIG. 6. In various embodiments, the attribute-based matching system uses an attribute-based product collection ML model (also referred to as item content attribute collection component, as described herein) to identify the one or more attributes of one or more items. The attribute-based product collection ML model (e.g., a second machine learning model) at least includes a pre-trained ML language model, such as Bidirectional Encoder Representations from Transformers (BERT). A person of ordinary skill in the art should appreciate that BERT provides language understanding capability based on pre-trained knowledge and self-attention to handle short and long sentences. Moreover, the attribute-based matching system adopts sentence-BERT (“SBERT”) to finetune the parameters of the attribute-based product collection ML model for matching textual attributes of products and corresponding attributes set with a triplet loss function. A person of ordinary skill in the art should appreciate that a loss function for ML algorithms or frameworks compares a reference input to a matching input and a non-matching input.

In various embodiments, the attribute-based matching system uses a ML model to generate a vector (e.g., a first vector) that represents one or more attributes of one or more influencers and generate a vector (e.g., a second vector) that represents one or more attributes of one or more items (or products). In various embodiments, the attribute-based matching system uses a personal-object similarity calculation ML model to generate vectors. Specifically, the attribute-based matching system uses the personal-object similarity calculation ML model (e.g., a third machine learning model) to calculate the similarity between attributes of nano-influencers and items based on the attribute representation generated by a previous attribute learning module. For example, the attribute-based matching system uses Mahalanobis Distance metric to measure the degrees of similarity between the nano-influencers and the items based on the respective attributes.

In various embodiments, the attribute-based matching system determines an item category (also referred to as product category, as described herein) based on the context data associated with the one or more influencers. The attribute-based matching system determines the one or more products based on the item category.

In various embodiments, the attribute-based matching system ranks the plurality of similarity scores in descending order and generates a list of influencers for the particular item category based on the ranking. In various embodiments, the attribute-based matching system causes the display of the list of influencers for the item category on the user interface of the device.

As used herein, a ML model can comprise any predictive model that is generated based on (or that is trained on) training data. Once generated/trained, a machine learning model can receive one or more inputs, extract one or more features, and generate an output for the inputs based on the model's training. Different types of machine learning models can include, without limitation, ones trained using supervised learning, unsupervised learning, reinforcement learning, or deep learning (e.g., complex neural networks).

Reference will now be made in detail to embodiments of the present disclosure, examples of which are illustrated in the appended drawings. The present disclosure may, however, be embodied in many different forms and should not be construed as being limited to the embodiments set forth herein.

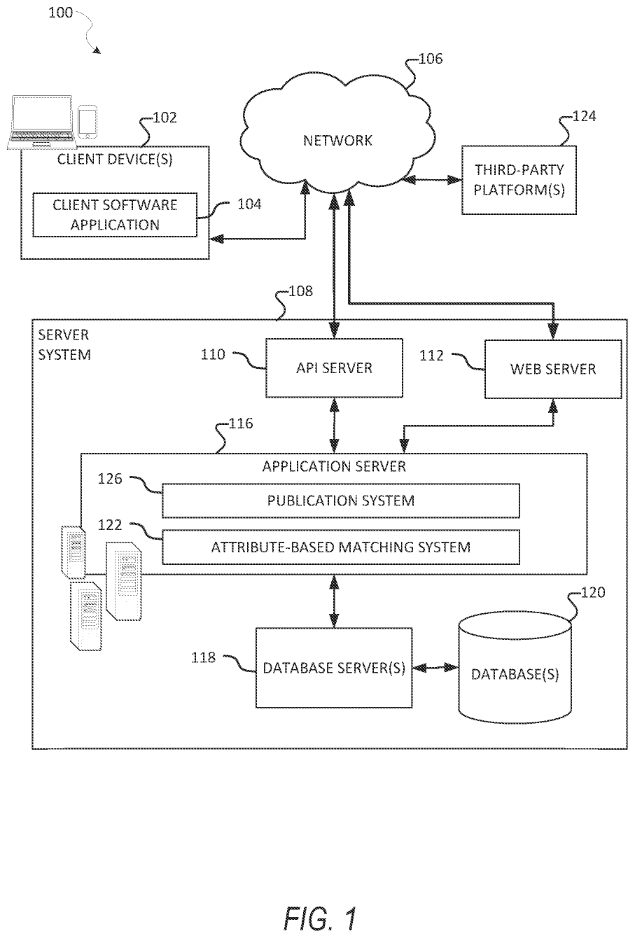

FIG. 1 is a block diagram showing an example data system 100 that includes an attribute-based matching system 122 (also referred to as system 122), according to various embodiments of the present disclosure. By including the attribute-based matching system 122, the data system 100 can facilitate identifying and matching influencers with categorized products using multimodal machine learning technologies. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the attribute-based matching system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the attribute-based matching system 122. Such operations include transmitting data from the attribute-based matching system 122 to the client software application 104, receiving data from the client software application 104 at the attribute-based matching system 122, and the attribute-based matching system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the attribute-based matching system 122. The application server 116 is communicatively coupled to a database server 118, which facilitates access to a database 120 that stores data associated with the application server 116, including data that may be generated or used by the attribute-based matching system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the attribute-based matching system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

The attribute-based matching system 122 may access item listing data from the publication system 126. The product system 126 may include item listings or product listings that include various product information, including without limitation, name, category, tags, brand, etc. Each item or product may be categorized based on a product taxonomy.

Through one or more web-based interfaces (e.g., web-based user interfaces), the web server 112 can support various functionality of the attribute-based matching system 122 of the application server 116.

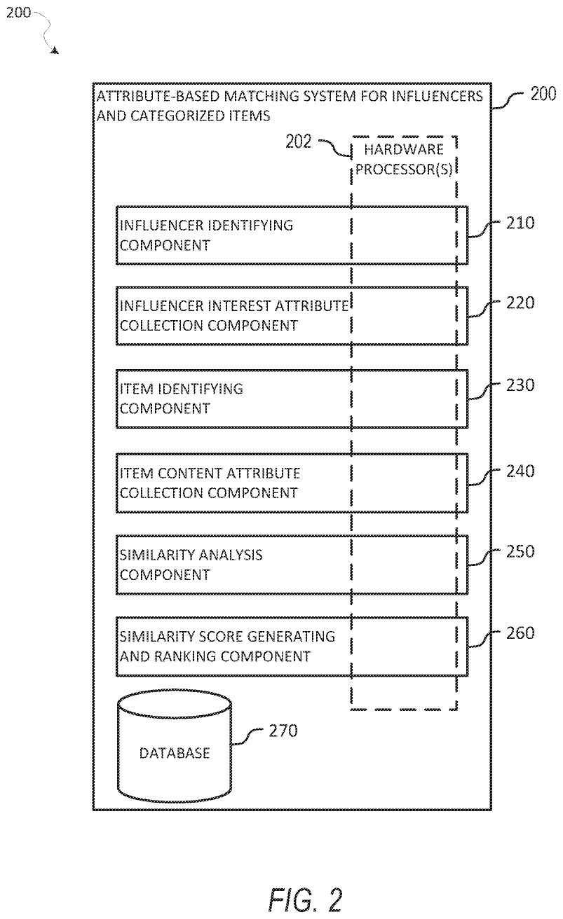

FIG. 2 is a block diagram illustrating an example attribute-based matching system 200 for influencers and categorized items, according to various embodiments of the present disclosure. For some embodiments, the attribute-based matching system 200 represents an example of the attribute-based matching system 122 described with respect to FIG. 1. As shown, the attribute-based matching system 200 comprises an influencer identifying component 210, an influencer interest attribute collection component 220, an item identifying component 230, an item content attribute collection component 240, a similarity analysis component 250, and a similarity score generating and ranking component 260. According to various embodiments, one or more of the influencer identifying component 210, the influencer interest attribute collection component 220, the item identifying component 230, the item content attribute collection component 240, the similarity analysis component 250, and the similarity score generating and ranking component 260 are implemented by one or more hardware processors 202. Data generated by one or more of the influencer identifying component 210, the influencer interest attribute collection component 220, the item identifying component 230, the item content attribute collection component 240, the similarity analysis component 250, and the similarity score generating and ranking component 260 may be stored in a database (or datastore) 270 of the attribute-based matching system 200.

The influencer identifying component 210 is configured to identify one or more influencers based on one or more criteria. The one or more criteria may include a predetermined range of a number of followers that is associated with an upper threshold number (e.g., 10,000) and a lower threshold number (e.g., 1,000), a login frequency (e.g., a fixed number per day), a category identification (e.g., electronics), one or more hashtags (e.g., #CMOS sensor), a frequency of interaction with followers, completeness of user profile, and/or available contact information.

The influencer identifying component 210 is configured to assign one or more weight values to the one or more criteria based on a plurality of priority rules, which may be defined by the attribute-based matching system or a system administrator. The attribute-based matching system may determine a plurality of influencers based on the one or more assigned weight values and rank the determined influencers in certain orders, such as descending order. This way, the attribute-based matching system may generate a list of influencers that best satisfies the plurality of priority rules.

The influencer identifying component 210 may include a machine learning model, such as a supervised ML learning model, to identify the one or more influencers based on one or more criteria. In various embodiments, the supervised learning model utilizes Naive Bayes classification algorithm.

The influencer interest attribute collection component 220 is configured to determine one or more attributes of the influencers based on context data associated with the influencers. The context data may be open-source poster data collected from various third-party social media platforms (e.g., third-party platforms 124). The context data may include user data and media, including text, image, video, audio, and metadata. Example metadata may include hashtags and labels. In various embodiments, the influencer interest attribute collection component 220 may include an influencer attribute collection module (or ML model). In various embodiments, the influencer attribute collection module may include a Graph Convolutional Networks (GCN) ML model (e.g., the first machine learning model) to determine one or more attributes of the influencer based on context data associated with the influencer.

The item identifying component 230 is configured to identify one or more items, such as products, associated with an e-commerce platform. The one or more items may be determined based on one or more item categories determined based on the context data associated with the one or more influencers.

The item content attribute collection component 240 is configured to identify one or more attributes of the one or more items. In various embodiments, a product or a class of products may contain various types of attributes including, without limitation, functionality attributes, style attributes, category attributes, and utility attributes, as illustrated in FIG. 6. In various embodiments, the item content attribute collection component 240 includes an attribute-based product collection ML model to identify the one or more attributes of one or more items. The attribute-based product collection ML model (e.g., the second machine learning model) at least includes a pre-trained ML language model, such as Bidirectional Encoder Representations from Transformers (BERT) or sentence-BERT (SBERT).

The similarity analysis component 250 is configured to generate a vector (e.g., the first vector) that represents the one or more attributes of one or more influencers and generate another vector (e.g., the second vector) that represents the one or more attributes of one or more items (or products). In various embodiments, the similarity analysis component 250 includes a personal-object similarity calculation ML model (e.g., the third machine learning model) to generate vectors. The personal-object similarity calculation ML model calculates the similarity between attributes of influencers (also referred to as nano-influencers, as described herein) and items based on the attribute representation generated by a previous attribute learning module. The personal-object similarity calculation ML model uses Mahalanobis Distance metric to measure the degrees of similarity between the influencers and the items based on the respective attributes.

The similarity score generating and ranking component 260 is configured to generate similarity scores based on the vector(s) that represents the one or more attributes of one or more influencers and the vector(s) that represents the one or more attributes of one or more items. The similarity score generating and ranking component 260 is configured to rank the similarity scores in a certain order (e.g., descending order) and generate a list of influencers for a particular item category based on the ranking.

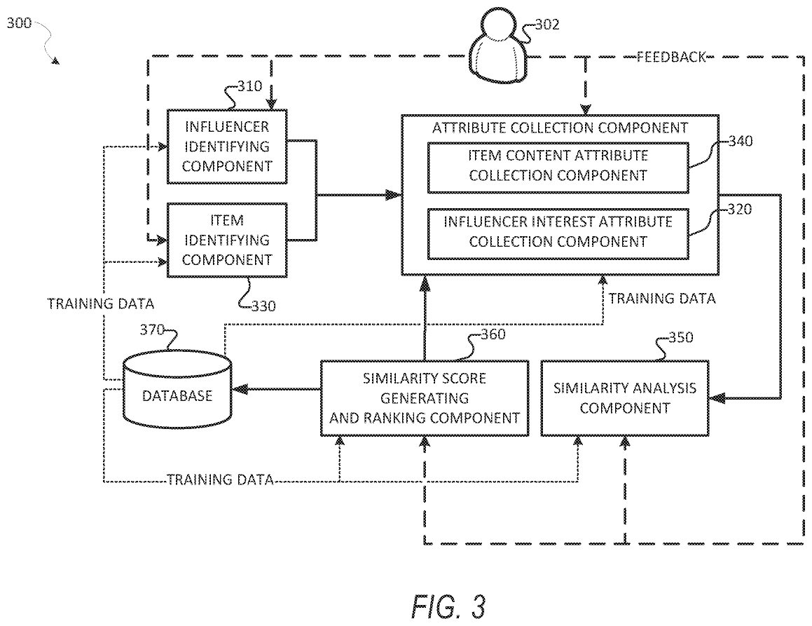

FIG. 3 is a diagram illustrating data flow within an example attribute-based matching system 300 for influencers and categorized items during operation, according to various embodiments of the present disclosure. As shown, the attribute-based matching system 300 comprises an influencer identifying component 310, an influencer interest attribute collection component 320, an item identifying component 330, an item content attribute collection component 340, a similarity analysis component 350, and a similarity score generating and ranking component 360 and a database 370. In various embodiments, the influencer identifying component 310, the influencer interest attribute collection component 320, the item identifying component 330, the item content attribute collection component 340, the similarity analysis component 350, and the similarity score generating and ranking component 360 are respectively similar to the influencer identifying component 210, the influencer interest attribute collection component 220, the item identifying component 230, the item content attribute collection component 240, the similarity analysis component 250, and the similarity score generating and ranking component 260 of the attribute-based matching system 200 of FIG. 2. Additionally, each of the influencer identifying component 310, the influencer interest attribute collection component 320, the item identifying component 330, the item content attribute collection component 340, the similarity analysis component 350, and the similarity score generating and ranking component 360 can comprise a machine learning (ML) model that enables or facilitates operation as described herein.

During operation, the influencer identifying component 310 identifies one or more influencers based on one or more criteria, as described herein. The influencer identifying component 310 may include one or more supervised ML learning models utilizing Naive Bayes classification algorithm.

During operation, the influencer interest attribute collection component 320 determines one or more attributes of the influencers based on context data associated with the influencers. The influencer interest attribute collection component 320 may include one or more Graph Convolutional Networks (GCN) ML models.

During operation, the item identifying component 330 identifies one or more items, such as products, associated with an e-commerce platform.

During operation, the item content attribute collection component 340 identifies one or more attributes of the one or more items. The item content attribute collection component 340 may include one or more pre-trained ML language models, including without limitation, Bidirectional Encoder Representations from Transformers (BERT) or sentence-BERT (SBERT).

During operation, the similarity analysis component 350 generates a vector (e.g., the first vector) that represents the one or more attributes of one or more influencers and generates a vector (e.g., the second vector) that represents the one or more attributes of one or more items (or products). The similarity analysis component 350 may include one or more personal-object similarity calculation ML models using Mahalanobis Distance metric.

During operation, the similarity score generating and ranking component 360 generates similarity scores based on the vector(s) that represents the one or more attributes of one or more influencers and the vector(s) that represents the one or more attributes of one or more items. The similarity score generating and ranking component 360 also ranks the similarity scores in a certain order (e.g., descending order) and generates a list of influencers for a particular item category based on the ranking.

As used herein, a ML model can be generated (or built) based on configured parameters and trained based on training data. Once generated and trained, a machine learning model can receive one or more inputs, extract one or more features, and generate an output for the inputs based on the model's training. A system administrator 302 (or an authorized user) may provide feedback to each component based on the outputs generated by the associated ML models and adjust the model parameters as needed to improve the accuracy of the outputs. Such a feedback loop mechanism (also referred to as closed-loop learning) leverages the outputs of ML models and the corresponding user inputs to retrain and improve models over time for better performance.

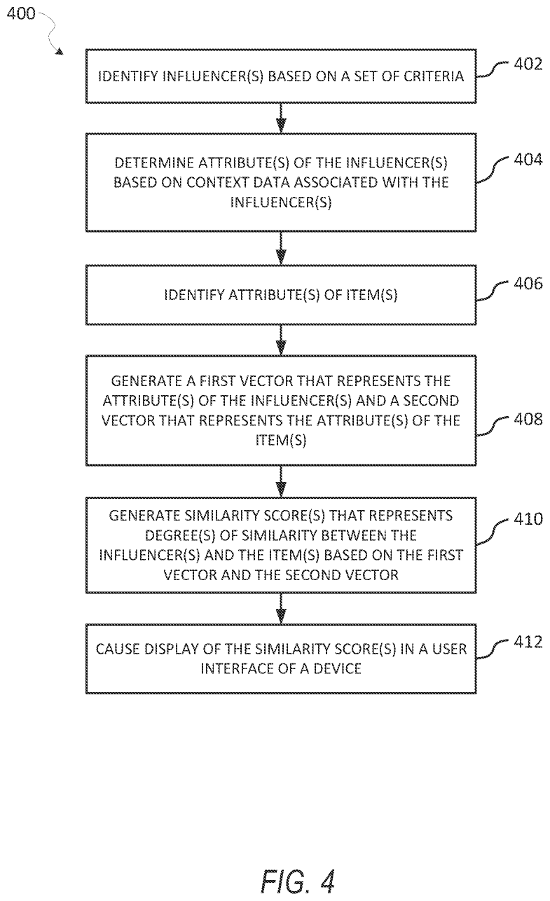

FIG. 4 is a flowchart illustrating an example method 400 for identifying and matching influencers with categorized items using multimodal machine learning, according to various embodiments of the present disclosure. It will be understood that example methods described herein may be performed by a machine in accordance with some embodiments. For example, method 400 can be performed by the attribute-based matching system 122 described with respect to FIG. 1, the attribute-based matching system 200 described with respect to FIG. 2, the attribute-based matching system described with respect to FIG. 3, or individual components thereof.

An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400.

Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 402, a processor uses one or more ML models (e.g., supervised ML learning models utilizing Naive Bayes classification algorithm) to identify one or more influencers based on one or more criteria. The one or more criteria may include a predetermined range of a number of followers that is associated with an upper threshold number (e.g., 10,000) and a lower threshold number (e.g., 1,000), a login frequency (e.g., a fixed number per day), a category identification (e.g., electronics), one or more hashtags (e.g., #CMOS sensor), a frequency of interaction with followers, completeness of user profile, and available contact information. The processor assigns one or more weight values to the one or more criteria based on a plurality of priority rules, which may be defined by the attribute-based matching system or a system administrator.

At operation 404, a processor uses one or more ML models (e.g., GCN ML models) to determine one or more attributes of the influencers based on context data associated with the influencers.

At operation 406, a processor uses one or more ML models (e.g., pre-trained ML language models, such as BERT or SBERT) to identify one or more attributes of the one or more items.

At operation 408, a processor uses one or more ML models (e.g., personal-object similarity calculation ML models using Mahalanobis Distance metric) to generate a vector (e.g., the first vector) that represents the one or more attributes of one or more influencers and generate another vector (e.g., the second vector) that represents the one or more attributes of one or more items (or products).

At operation 410, a processor uses one or more ML models (e.g., personal-object similarity calculation ML models using Mahalanobis Distance metric) to generate similarity scores based on the vector(s) that represents the one or more attributes of one or more influencers and the vector(s) that represents the one or more attributes of one or more items.

At operation 412, a processor causes the display of the similarity scores on a user interface of a device.

Though not illustrated, method 400 can include an operation where a graphical user interface for identifying and matching influencers with categorized products can be displayed (or caused to be displayed) by the hardware processor. For instance, the operation can cause a client device (e.g., the client device 102 communicatively coupled to the attribute-based matching system 122) to display the graphical user interface. This operation for displaying the graphical user interface can be separate from operations 402 through 412 or, alternatively, form part of one or more of operations 402 through 412.

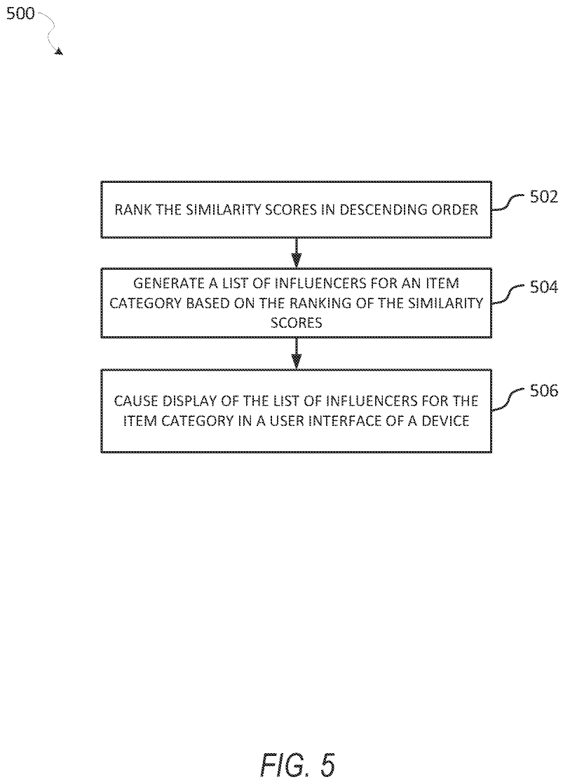

FIG. 5 is a flowchart illustrating an example method 500 for identifying and matching influencers with categorized items using multimodal machine learning, according to various embodiments of the present disclosure. It will be understood that example methods described herein may be performed by a machine in accordance with some embodiments. For example, method 500 can be performed by the attribute-based matching system 122 described with respect to FIG. 1, the attribute-based matching system 200 described with respect to FIG. 2, the attribute-based matching system described with respect to FIG. 3, or individual components thereof.

An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 500 may be represented by executable instructions that, when executed by a processor of a computing device, cause the computing device to perform method 500.

Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. In various embodiments, method 500 may be a subroutine of method 400, or alternatively, be independent of operations described in method 400.

At operation 502, a processor ranks the similarity scores in a certain order (e.g., descending order).

At operation 504, a processor generates a list of influencers for one or more items or item categories based on the ranking.

At operation 506, a processor causes the display of the list of influencers for the one or more items or item categories in a user interface of a device.

Though not illustrated, method 500 can include an operation where a graphical user interface for identifying and matching influencers with categorized products can be displayed (or caused to be displayed) by the hardware processor. For instance, the operation can cause a client device (e.g., the client device 102 communicatively coupled to the attribute-based matching system 122) to display the graphical user interface. This operation for displaying the graphical user interface can be separate from operations 502 through 506 or, alternatively, form part of one or more of operations 502 through 506.

FIG. 6 is a diagram illustrating an example item listing 600 of a categorized item and the associated attributes, according to various embodiments of the present disclosure. As shown, item 602 is a camera. The item listing 600, accessed from the publication system 126, for example, includes the name, category, tags, brand, etc. The item content attribute collection component 240 and 340 of the attribute-based matching system 122 and 200 may use a pre-trained language ML model (e.g., BERT OR SBERT) to identify or generate various types of attributes (collectively referred to as attribute set) that include functionality attributes 604 (e.g., sensor), style attributes 606 (e.g., color black), category attributes 608 (e.g., camera), and utility attributes 610 (e.g., 3.0-inch, LCD, and battery).

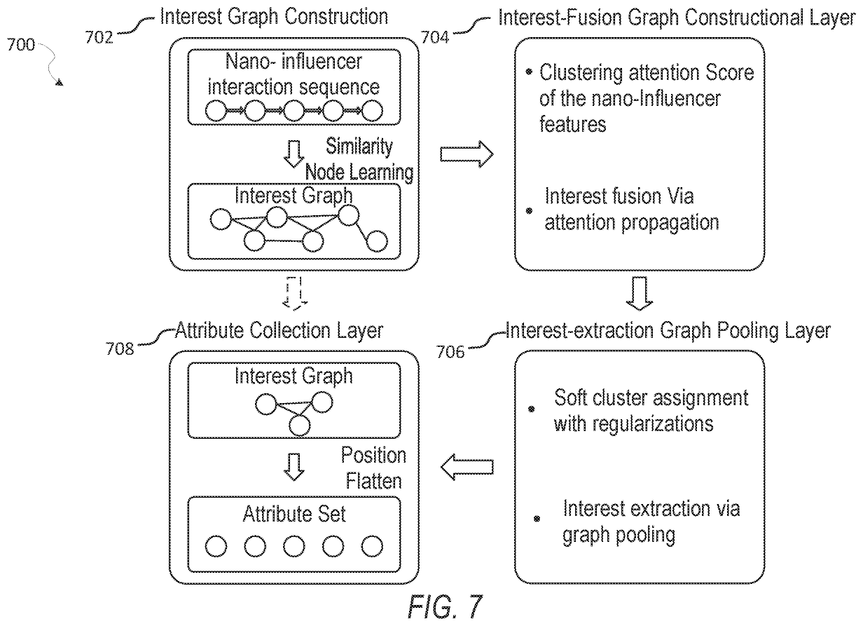

FIG. 7 is a diagram illustrating data flow 700 within an example influencer interest attribute collection component (e.g., influencer interest attribute collection component 220, 320) during operation, according to various embodiments of the present disclosure. As shown, the example influencer interest attribute collection component includes four layers: interest graph construction layer 702, interest-fusion graph constructional layer 704, interest-extraction graph pooling layer 706, and attribute collection layer 708.

Interest Graph Construction Layer 702: by re-constructing loose interaction sequences as tight interest graphs based on similarity learning, the attribute-based matching system explicitly integrates and distinguishes various types of influencers' (e.g., nano-influencers) preferences in a time window.

Interest-fusion Graph Constructional Layer 704: the graph convolutional operation on the constructed interest graph dynamically fuses the influencer's interest, strengthens important attributes, and reduces the impact of noisy data (e.g., meaningless data).

Interest-extraction Graph Pooling Layer 706: an influencer may have different preferences at different moments. The dynamic graph pooling operation can dynamically reserve activated core attributes over a period of time.

Attribute Collection Layer 708: after the pooled graphs are flattened into reduced sequences, the attribute-based matching system collects core attributes that are more representative of influencers' preferences.

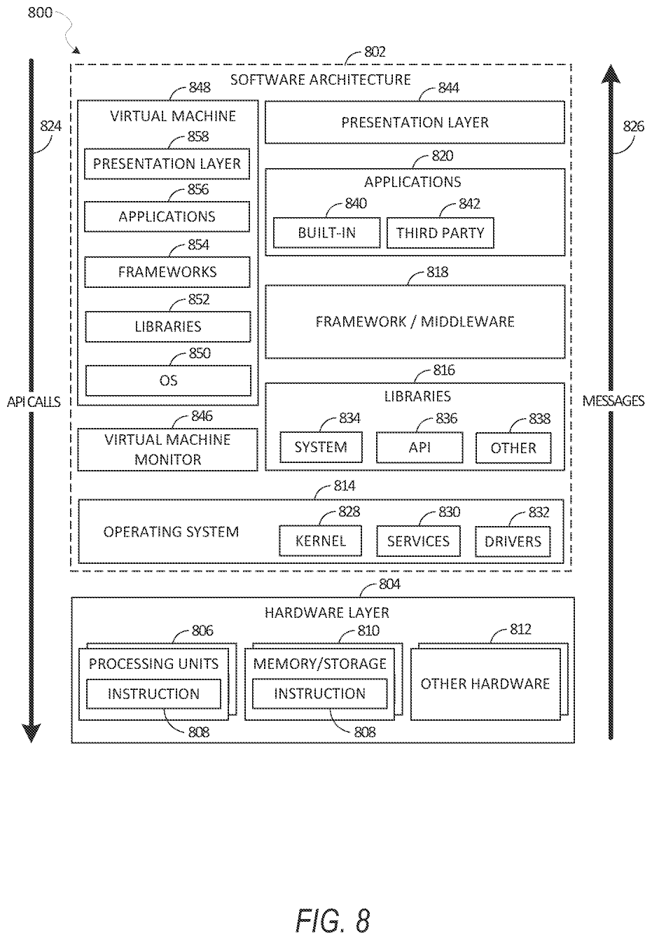

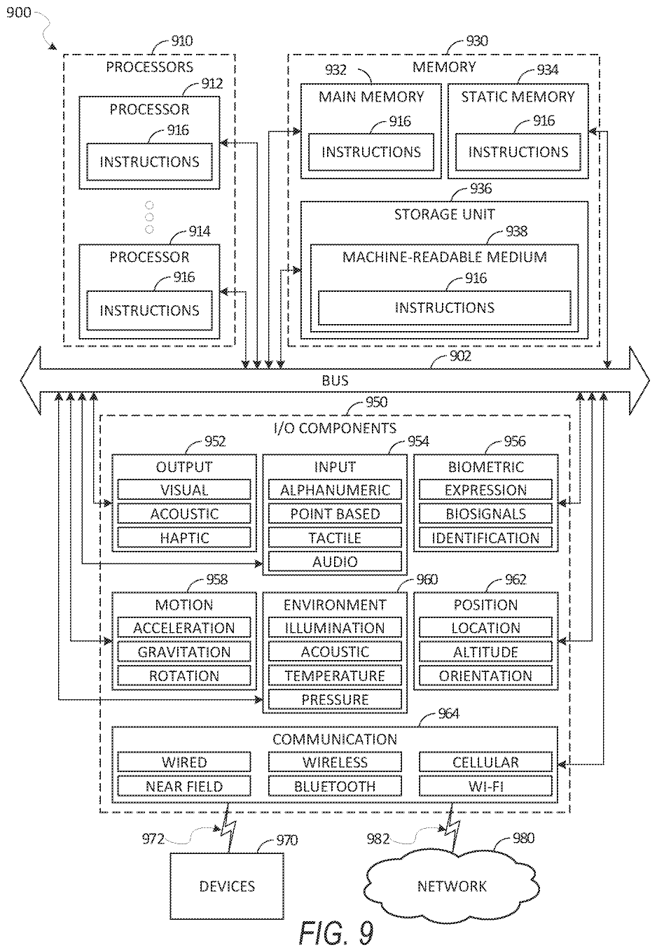

FIG. 8 is a block diagram illustrating an example of a software architecture 802 that may be installed on a machine, according to some example embodiments. FIG. 8 is merely a non-limiting example of a software architecture, and it will be appreciated that many other architectures may be implemented to facilitate the functionality described herein. The software architecture 802 may be executing on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 comprises one or more processing units 806 having associated executable instructions 808. The executable instructions 808 represent the executable instructions of the software architecture 802. The hardware layer 804 also includes memory or storage modules 810, which also have the executable instructions 808. The hardware layer 804 may also comprise other hardware 812, which represents any other hardware of the hardware layer 804, such as the other hardware illustrated as part of the machine 900.

In the example architecture of FIG. 8, the software architecture 802 may be conceptualized as a stack of layers, where each layer provides particular functionality. For example, the software architecture 802 may include layers such as an operating system 814, libraries 816, frameworks/middleware 818, applications 820, and a presentation layer 844. Operationally, the applications 820 or other components within the layers may invoke API calls 824 through the software stack and receive a response, returned values, and so forth (illustrated as messages 826) in response to the API calls 824. The layers illustrated are representative in nature, and not all software architectures have all layers. For example, some mobile or special-purpose operating systems may not provide a frameworks/middleware 818 layer, while others may provide such a layer. Other software architectures may include additional or different layers.

The operating system 814 may manage hardware resources and provide common services. The operating system 814 may include, for example, a kernel 828, services 830, and drivers 832. The kernel 828 may act as an abstraction layer between the hardware and the other software layers. For example, the kernel 828 may be responsible for memory management, processor management (e.g., scheduling), component management, networking, security settings, and so on. The services 830 may provide other common services for the other software layers. The drivers 832 may be responsible for controlling or interfacing with the underlying hardware. For instance, the drivers 832 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 816 may provide a common infrastructure that may be utilized by the applications 820 and/or other components and/or layers. The libraries 816 typically provide functionality that allows other software modules to perform tasks in an easier fashion than by interfacing directly with the underlying operating system 814 functionality (e.g., kernel 828, services 830, or drivers 832). The libraries 816 may include system libraries 834 (e.g., C standard library) that may provide functions such as memory allocation functions, string manipulation functions, mathematic functions, and the like. In addition, the libraries 816 may include API libraries 836 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 816 may also include a wide variety of other libraries 838 to provide many other APIs to the applications 820 and other software components/modules.

The frameworks 818 (also sometimes referred to as middleware) may provide a higher-level common infrastructure that may be utilized by the applications 820 or other software components/modules. For example, the frameworks 818 may provide various graphical user interface functions, high-level resource management, high-level location services, and so forth. The frameworks 818 may provide a broad spectrum of other APIs that may be utilized by the applications 820 and/or other software components/modules, some of which may be specific to a particular operating system or platform.

The applications 820 include built-in applications 840 and/or third-party applications 842. Examples of representative built-in applications 840 may include, but are not limited to, a home application, a contacts application, a browser application, a book reader application, a location application, a media application, a messaging application, or a game application.

The third-party applications 842 may include any of the built-in applications 840, as well as a broad assortment of other applications. In a specific example, the third-party applications 842 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 842 may invoke the API calls 824 provided by the mobile operating system such as the operating system 814 to facilitate functionality described herein.

The applications 820 may utilize built-in operating system functions (e.g., kernel 828, services 830, or drivers 832), libraries (e.g., system libraries 834, API libraries 836, and other libraries 838), or frameworks/middleware 818 to create user interfaces to interact with users of the system. Alternatively, or additionally, in some systems, interactions with a user may occur through a presentation layer, such as the presentation layer 844. In these systems, the application/module “logic” can be separated from the aspects of the application/module that interact with the user.

Some software architectures utilize virtual machines. In the example of FIG. 8, this is illustrated by a virtual machine 848. The virtual machine 848 creates a software environment where applications/modules can execute as if they were executing on a hardware machine (e.g., the machine 900 of FIG. 9). The virtual machine 848 is hosted by a host operating system (e.g., the operating system 814) and typically, although not always, has a virtual machine monitor 846, which manages the operation of the virtual machine 848 as well as the interface with the host operating system (e.g., the operating system 814). A software architecture executes within the virtual machine 848, such as an operating system 850, libraries 852, frameworks/middleware 854, applications 856, or a presentation layer 858. These layers of software architecture executing within the virtual machine 848 can be the same as corresponding layers previously described or may be different.

FIG. 9 illustrates a diagrammatic representation of a machine 900 in the form of a computer system within which a set of instructions may be executed for causing the machine 900 to perform any one or more of the methodologies discussed herein, according to an embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the method 400 described above with respect to FIG. 4. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an embodiment, the processors 910 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936 including machine-readable medium 938, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the U/O components 950 may include biometric components 956, motion components 958, environmental components 960, or position components 962, among a wide array of other components. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In various embodiments, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 900 including processors 910), with these operations being accessible via a network (e.g., the Internet) and via one or more appropriate interfaces (e.g., an API). In certain embodiments, for example, a client device may relay or operate in communication with cloud computing systems, and may access circuit design information in a cloud environment.

The performance of certain of the operations may be distributed among the processors, not only residing within a single machine 900, but deployed across a number of machines 900. In some example embodiments, the processors 910 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 930, 932, 934, and/or the memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various embodiments, one or more portions of the network 980 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
identifying an influencer based on a set of criteria;
using a first machine learning model to determine a first attribute of the influencer based on context data associated with the influencer;
using a second machine learning model to identify a second attribute of an item;
using a third machine learning model to generate a first vector that represents the first attribute of the influencer and a second vector that represents the second attribute of the item;
generating a similarity score that represents a degree of similarity between the influencer and the item based on the first vector and the second vector; and
causing display of the similarity score in a user interface of a device.

2. The method of claim 1, further comprising:
determining an item category based on the context data associated with the influencer; and
identifying the item based on the item category.

3. The method of claim 1, further comprising:
determining a set of influencer interest attributes based on a plurality of influencers, the plurality of influencers being identified based on the set of criteria;
generating a third vector that represents the set of influencer interest attributes;
generating a set of category-based item attributes based on a plurality of items associated with an item category;
generating a fourth vector that represents the set of category-based item attributes; and
generating, based on the third vector and the fourth vector, a plurality similarity scores that represents degrees of similarity between the plurality of influencers and the plurality of items associated with the item category.

4. The method of claim 3, further comprising:
ranking the plurality of similarity scores in descending order;
generating a list of influencers for the item category based on the ranking of the plurality of similarity scores; and
causing display of the list of influencers for the item category in the user interface of the device.

5. The method of claim 1, wherein the first machine learning model corresponds to a Graph Convolutional Networks (GCN) machine learning model associated with a multimodal machine learning framework.

6. The method of claim 1, wherein the second machine learning model corresponds to a language model associated with Bidirectional Encoder Representations from Transformers (BERT) technique.

7. The method of claim 1, wherein the third machine learning model corresponds to a personal-object similarity calculation machine learning model.

8. The method of claim 1, wherein the influencer is identified using a supervised machine learning model associated with a Naive Bayes classification algorithm.

9. The method of claim 1, wherein the set of criteria includes one or more of a predetermined range of a number of followers that is associated with an upper threshold number and a lower threshold number, a login frequency, a category identification, one or more hashtags, a frequency of interaction with followers, completeness of user profile, or contact information.

10. The method of claim 1, further comprising:
assigning one or more weight values to the set of criteria;
determining a plurality of influencers based on the one or more weight values; and
identifying the influencer from the plurality of influencers, the influencer being associated with a highest weight value.

11. A system comprising:
a memory storing instructions; and
one or more hardware processors communicatively coupled to the memory and configured by the instructions to perform operations comprising:
identifying an influencer based on a set of criteria;
using a first machine learning model to determine a first attribute of the influencer based on context data associated with the influencer;
using a second machine learning model to identify a second attribute of an item;
using a third machine learning model to generate a first vector that represents the first attribute of the influencer and a second vector that represents the second attribute of the item;
generating a similarity score that represents a degree of similarity between the influencer and the item based on the first vector and the second vector; and
causing display of the similarity score in a user interface of a device.

12. The system of claim 11, wherein the operations further comprise:
determining an item category based on the context data associated with the influencer; and
identifying the item based on the item category.

13. The system of claim 11, wherein the operations further comprise:
determining a set of influencer interest attributes based on a plurality of influencers, the plurality of influencers being identified based on the set of criteria;
generating a third vector that represents the set of influencer interest attributes;
generating a set of category-based item attributes based on a plurality of items associated with an item category;
generating a fourth vector that represents the set of category-based item attributes; and
generating, based on the third vector and the fourth vector, a plurality similarity scores that represents degrees of similarity between the plurality of influencers and the plurality of items associated with the item category.

14. The system of claim 13, wherein the operations further comprise:
ranking the plurality of similarity scores in descending order;
generating a list of influencers for the item category based on the ranking of the plurality of similarity scores; and
causing display of the list of influencers for the item category in the user interface of the device.

15. The system of claim 11, wherein the first machine learning model corresponds to a Graph Convolutional Networks (GCN) machine learning model associated with a multimodal machine learning framework.

16. The system of claim 11, wherein the second machine learning model corresponds to a language model associated with Bidirectional Encoder Representations from Transformers (BERT) technique.

17. The system of claim 11, wherein the third machine learning model corresponds to a personal-object similarity calculation machine learning model.

18. The system of claim 11, wherein the set of criteria includes one or more of a predetermined range of a number of followers that is associated with an upper threshold number and a lower threshold number, a login frequency, a category identification, one or more hashtags, a frequency of interaction with followers, completeness of user profile, or contact information.

19. The system of claim 11, further comprising:
assigning one or more weight values to the set of criteria;
determining a plurality of influencers based on the one or more weight values; and
identifying the influencer from the plurality of influencers, the influencer being associated with a highest weight value.

20. A non-transitory computer-readable medium comprising instructions that, when executed by a hardware processor of a device, cause the device to perform operations comprising:
identifying an influencer based on a set of criteria;
using a first machine learning model to determine a first attribute of the influencer based on context data associated with the influencer;
using a second machine learning model to identify a second attribute of an item;
using a third machine learning model to generate a first vector that represents the first attribute of the influencer and a second vector that represents the second attribute of the item;
generating a similarity score that represents a degree of similarity between the influencer and the item based on the first vector and the second vector; and
causing display of the similarity score in a user interface of a device.
